(19) United States
(12) Patent Application Publication
(10) Pub. No.: US 2024/0033897 A1
(43) Pub. Date: Feb. 1, 2024

(54) Tools and parts caddy for man-lifts

(71) Applicant: David Lindsay, Cleveland Heights, OH (US)

(72) Inventor: David Lindsay, Cleveland Heights, OH (US)

(21) Appl. No.: 18/445,463

(22) Filed: Aug. 28, 2023

Related U.S. Application Data
(60) Provisional application No. 63/577,383, filed on Apr. 21, 2023.

(51) Int. Cl. B25H 5/00

(52) U.S. Cl. CPC B25H 5/00

(57) ABSTRACT

The present invention is a Tools and Parts Caddy, which holds tools and parts/fasteners, etc. within easy reach while removably affixed on a scissor lift or other type of man-lift. The core component of the invention is an injection-molded plastic tray, which, generally speaking, is configured as follows: a flat area with slots and holes for holding various hand tools, a bin for fasteners and parts which can be removably attached to the rails of the man-lift. Several accessories are envisioned to accommodate larger tools and parts secured to the lower rails and a trash container which rests on the floor of the work platform. The invention can be used by all building and maintenance trades to augment or replace tool belts and pouches. Furthermore, it should be noted that using this device increases efficiencies and reduces strain and exertion required performing tasks.

### CROSS REFERENCE TO RELATED APPLICATION

This application claims priority from provisional patent application 63/577,383 filed on Apr. 21, 2023.

### BACKGROUND OF THE INVENTION

### 1. Field of the Invention

The invention relates generally to a tools and parts caddy and more specifically to a caddy specifically adapted for use with man-lifts including scissor-lifts.

### 2. Description of the Prior Art

Currently, there are a number of known industry solutions for organizing tools and parts on a man-lift, but they generally comprise merely a bucket or pouch. The present invention provides a tools and parts caddy which is adapted to be removably affixed to the man-lift and which is adapted to receive tools and parts in an organized fashion so as to allow the “man-lift” occupant to conveniently reach and use such tools and parts in completing the job that such occupant is attempting to complete.

### SUMMARY OF THE INVENTION

Platforms on man-lifts typically include only a cage and occupants find themselves constantly bending down to the floor to use various tools, equipment fasteners and parts and the like. The device of the present invention advantageously fills these needs and addresses the aforementioned deficiencies by providing a comfortable and more convenient workspace by means of the herein disclosed and claimed tools and parts caddy.

The tools and parts caddy of the present invention can be preferably made of an injection-molded single-piece device, held in place with “hook and loop” straps to resist wind and potential displacement due to impacts from equipment or occupant. Preferably, the caddy can be an “L” shaped device, that even more preferably rests on the horizontal guardrails of the work platform with the left side being a long bin and the short end being a flat surface with various slots and holes that receive hand tools and keep them within easy reach while working.

The device may also preferably have one or more of the following: an intermediate deep tray resting on the mid-rail of the man-lift for larger tools and equipment and a waste basket/debris containment component resting on the floor. Furthermore, other options could include magnetic surfaces for levels and loose fasteners and parts, a bench vise, tape ruler clip, and such other parts and/or tools.

The disclosed device is unique when compared with other known devices and solutions because it provides: (1) Better organization of tools, parts and fasteners than “buckets” due to the slots and holes and (2) Ergonomically friendlier than bending to the floor and back all day.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The Tools and Parts Caddy for Man-lifts may, however, be embodied in many different forms and should not be construed as being limited to the embodiments set forth herein; rather, these embodiments are provided by way of illustration only and so that this disclosure will be thorough, complete and full for the benefit of those skilled in the art.

### BRIEF DESCRIPTION OF THE DRAWINGS

FIG. 1.— Isometric Top View showing the tools and parts caddy of the present invention removably affixed to a typical man-lift.

FIG. 2.— Isometric Bottom View of the tools and parts caddy without the man-lift.

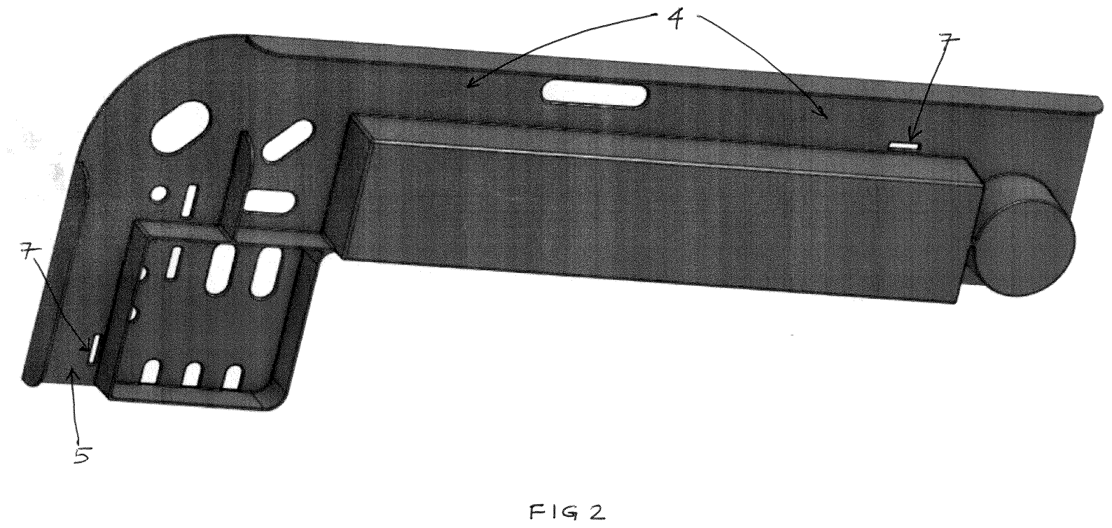

FIG. 3.— Isometric Close-up Left-handed Top View showing the tools and parts caddy of the present invention removably affixed to a typical man-lift.

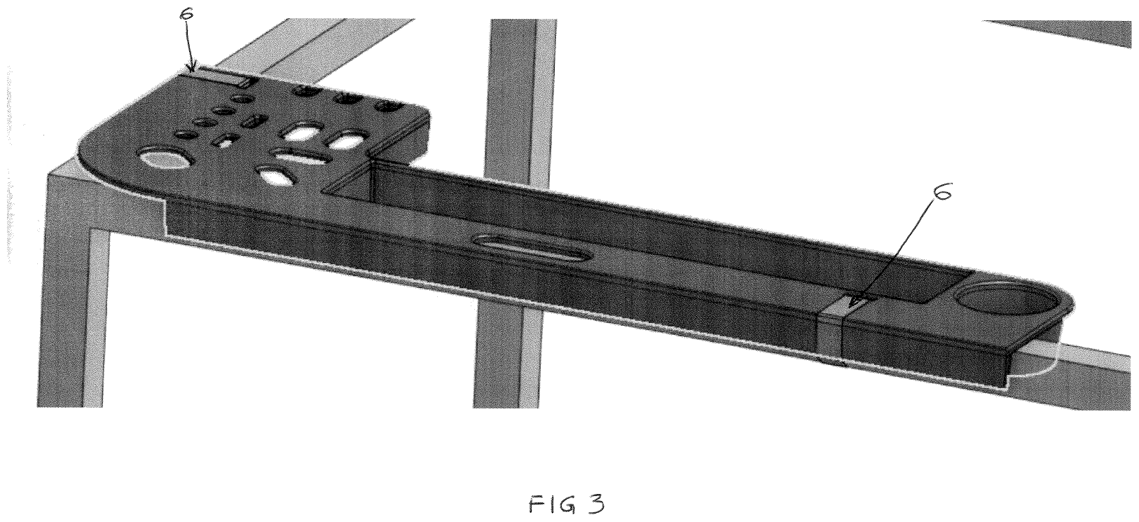

FIG. 4.— Isometric Left-handed Close-up Bottom View showing the tools and parts caddy of the present invention.

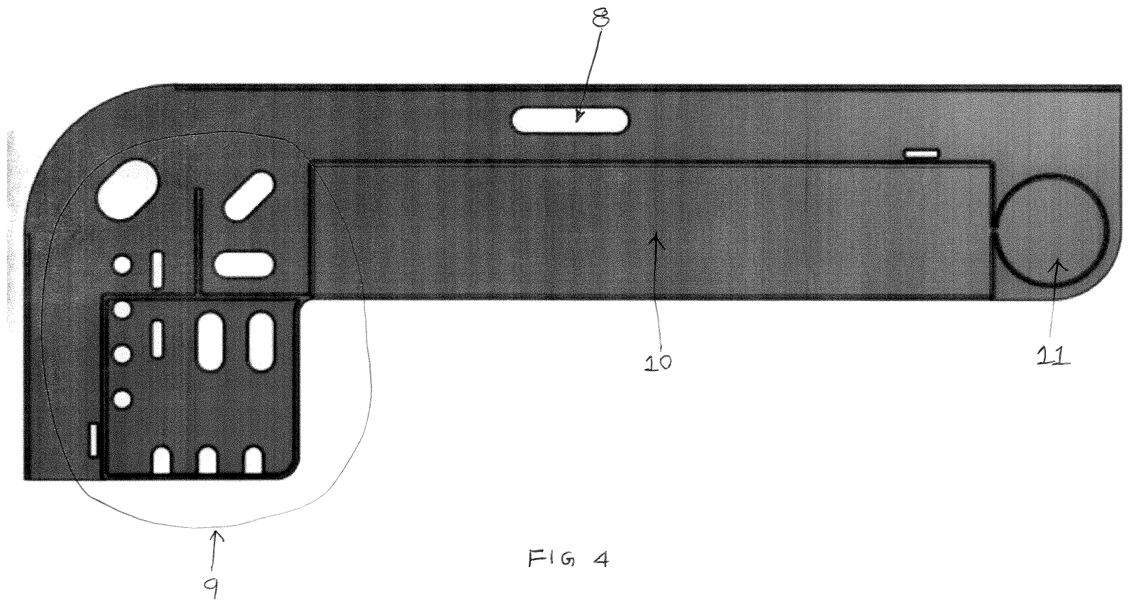

FIG. 5.— Isometric Right-handed Close-up Bottom View showing the tools and parts caddy of the present invention removably affixed to a typical man-lift.

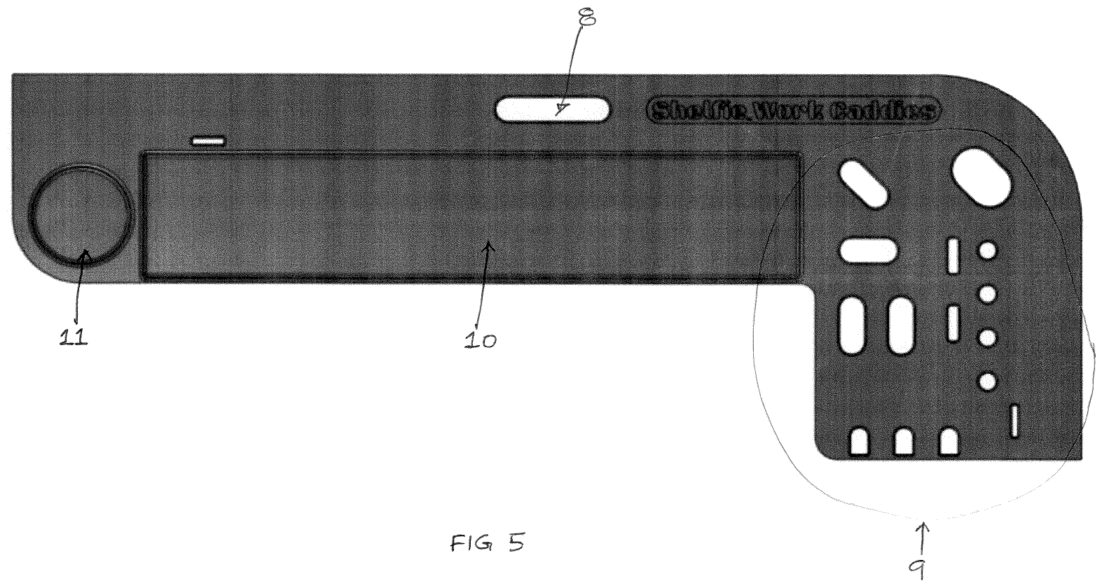

FIG. 6.— Isometric perspective Bottom View showing the tools and parts caddy of the present invention.

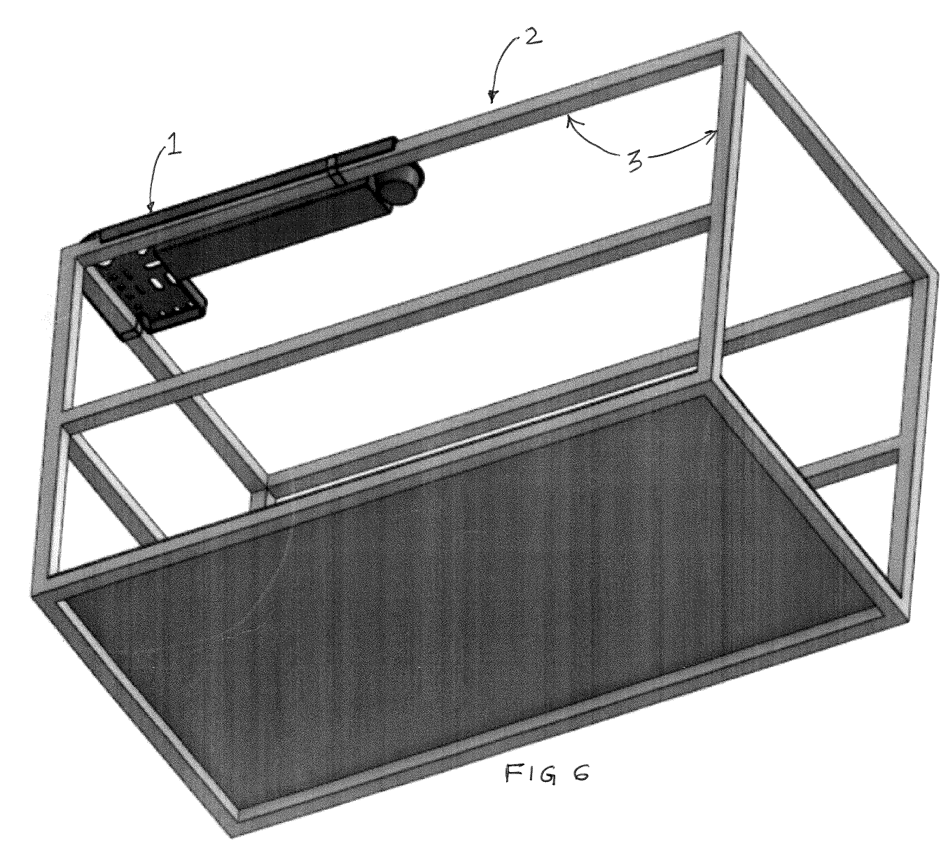

FIG. 7.— Isometric Close-up Right-handed Top View showing the tools and parts caddy of the present invention including a ferrous metal plate removably affixed to a typical man-lift.

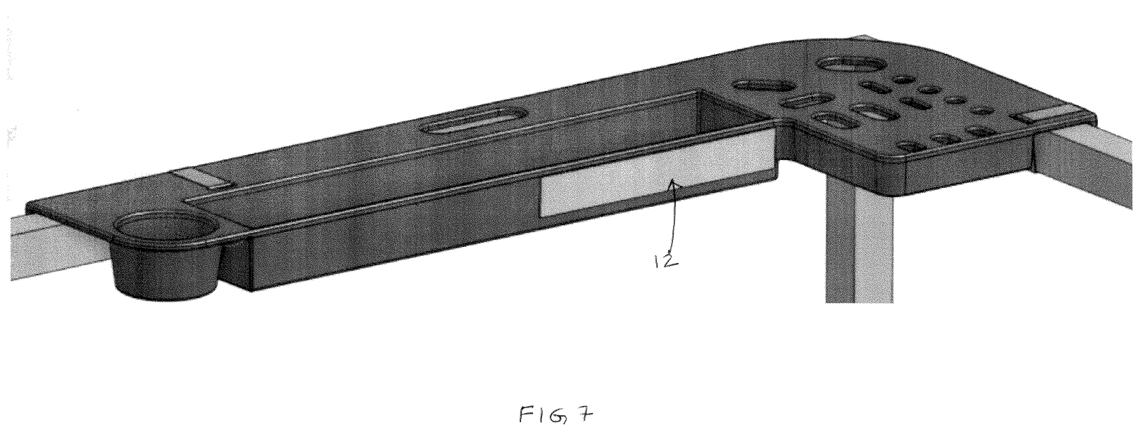

### DESCRIPTION OF THE PREFERRED EMBODIMENTS

The present invention is directed to Tools and Parts Caddy for Man-lifts.

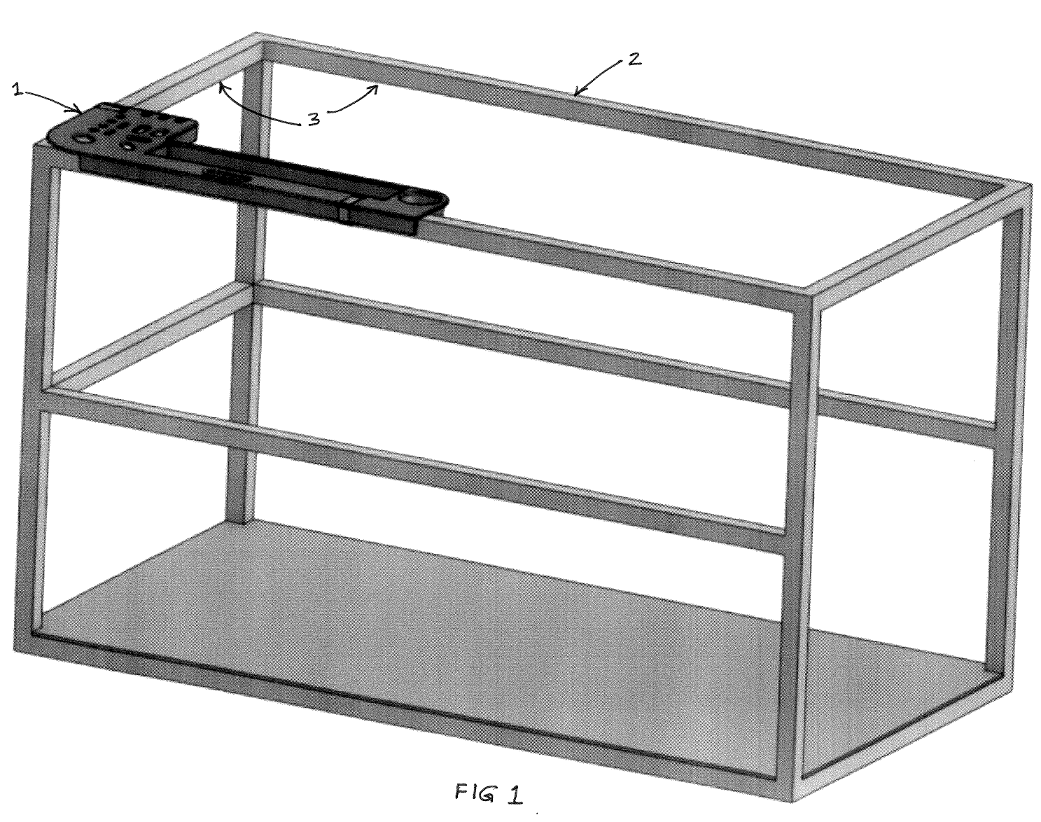

FIG. 1 shows the device (1) mounted onto a typical man-lift (2). The device is designed to fit onto the rails (3) of the man-lift (2) by means of channels (4) and (5) formed into the device (1), and is secured in place onto the rails (3) by one of several possible means. The presently described embodiment is shown using hook-and-loop straps (6) which loop through holes (7) formed in the device (1) and wrap around the rails (3). A carrying handle (8) may also be provided in the form of a though hole (8) at or near the center of mass of the device (1) to facilitate easy transport.

The device may include sections which are means to hold various parts and/or tools. Among these may be a flat area (9) which are in the form of holes for holding various types of hand tools such as wrenches, screwdrivers and the like. Another section may include a large recessed tray (10) for holding larger items such as power tools, fastener boxes and the like. Another section may include a cup holder (11) that is formed into the device (1). A further may include a ferrous metal plate (12) to be used to hold magnetic tools or parts. In its most preferred version, the device is made up of the following components:
(1) Top Tool and Parts Caddy
(2) Mid-height Tray for Bigger Tools and Parts
(3) Trash/Debris Containment Unit

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific

1. A tools and parts caddy for use in conjunction with man-lifts including an occupant, comprising:
a shaped device adapted to be removably attached to said man-lift,
said device including at least one hole and at least one receptacle for removably receiving tools and parts,
said device being shaped to attach to man-lift such that it facilitates removal of said tools and parts by said occupant.

2. The caddy of claim 1, being formed by an injection molding process.

3. The caddy of claim 1, being L-shaped with a longer section and a shorter section.

4. The caddy of claim 1, having an underside which fits removably onto the man-lift.

5. The caddy of claim 3, wherein the outer portion of the L is right-angled.

6. The caddy of claim 3, wherein the outer portion of the L is rounded.

7. The caddy of claim 1, including a magnetic surface for removably attaching ferrous parts and tools.

8. The caddy of claim 1, including an area for receiving larger tools and parts.

9. The caddy of claim 1, including a trash/debris container.

10. The caddy of claim 1, including a cup holder.

11. The caddy of claim 1, which is attached to said man-lift by hook-and-loop straps.

12. The caddy of claim 3, further including a bench vise.

13. The caddy of claim 3, further including a tape ruler clip.
